(19) United States
(12) Patent Application Publication
(10) Pub. No.: US 2011/0018788 A1
(43) Pub. Date: Jan. 27, 2011

(54) ORGANIC EL DISPLAY DEVICE

(75) Inventors: Masahiro Tanaka, Chiba (JP); Kazuhiko Kai, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/840,355

(22) Filed: Jul. 21, 2010

(30) Foreign Application Priority Data
Jul. 22, 2009 (JP) 2009-171013

(51) Int. Cl. G09G 3/30

(52) U.S. Cl. 345/80

(57) ABSTRACT

A solid-sealing type organic EL display device having an excellent mechanical strength, sealed by a highly reliable sealing method and in which the luminescence property is less deteriorated. A laminate film including a thermoplastic adhesive member and a barrier layer against moisture is disposed on an upper electrode that is situated over an organic EL layer. In a sealing part existed in a periphery of the display region, only a metal oxide film which is formed of metal alkoxide exists between an edge of the laminate film and the element substrate. The organic EL element is surrounded only by an inorganic film so that moisture permeation from the outside can be prevented. Moreover the sealing part is composed of the inorganic film having an excellent sealing property against water thereby it is possible to make a width of the sealing part small.

### CLAIM OF PRIORITY

The present application claims priority from Japanese Patent Application JP 2009-171013 filed on Jul. 22, 2009, the content of which is hereby incorporated by reference into this application.

### BACKGROUND OF THE INVENTION

1. Technical Field

The present invention relates to a display device, particularly an organic electro-luminescence (EL) display device in which deterioration of an organic EL element due to water is prevented.

2. Related Art

In an organic EL display device, an organic EL layer is interposed between a lower electrode and an upper electrode. Luminescence of the organic EL layer is controlled by applying a fixed voltage to the upper electrode and applying a data signal voltage to the lower electrode. The data signal voltage is supplied to the lower electrode through a thin film transistor (TFT). The organic EL layer emits red, green or blue light depending on a material of an emissive layer. A pixel including such organic EL layer and the TFT is arranged in matrix and an image is formed by controlling luminescence of each pixel.

There are two types of the organic EL display device, one is a bottom-emission type in which light from the organic EL layer is emitted toward a glass substrate on which the organic EL layer and the like is formed, and the other is a top-emission type in which light is emitted toward the opposite side that is remote from the glass substrate where the organic EL layer and the like is formed. The top-emission type has an advantage that an emission region can be formed over an area where the TFT is formed.

Luminescence property are deteriorated when water exists in an organic EL material of the organic EL display device, and the area where the luminescence property are deteriorated due to water will stop emitting light eventually while the device is operated for a long period of time. Such area appears as a dark spot in a display region. The dark spot grows as time advances and results in an image defect. Moreover a so-called “edge growth” phenomenon in which an area where is not luminous increases in a periphery of a display.

In order to prevent a dark spot and the like from being generated or grown, it is necessary to stop water seeping into an organic EL display device or to remove water intruded in the device. Conventionally, an element substrate on which the organic EL layer is formed is sealed by a sealing substrate with a sealant which is arranged along the periphery of the element substrate. This is one of the techniques developed to prevent water from coming inside the organic EL display device. A sealed space is filled with an inactive gas such as N₂. At the same time, desiccant is provided inside the organic EL display device in order to remove the water that is penetrated in the organic EL display device. Such organic EL display device is referred as to a hollow-sealing type organic EL display device.

JP-A-2003-308964 is a first example of the related art. JP-A-2003-308964 discloses a hollow-sealing type organic EL display device in which an element substrate and a sealing substrate are sealed with an adhesive whose major component is obtained from a sol-gel solution. JP-A-2003-308964 also disclose a feature in which rubber having a moisture absorption property or a deoxidation property is provided inside the sealing member in order to protect the organic EL layer inside. In addition, the document discloses a feature in which the rubber member is provided all over an inner wall of the sealing substrate in order to enhance a mechanical strength of the sealing substrate.

However the hollow-sealing type organic EL display device has disadvantages that adjustment of a gap between the element substrate and the sealing substrate is difficult, the sealant which adhesively bonds the element substrate with the sealing substrate at their periphery must have a large width in order to prevent water from intruding inside, an organic EL material can be contaminated with a gas emitted from the sealant when the substrate is sealed with the sealant, throughput is low and so forth. Moreover, another disadvantage in a completed EL display device is that the organic EL layer can be damaged when the element substrate and the sealing substrate contact each other by an external force applied to the element substrate or the sealing substrate.

JP-A-2007-156058 is a second example of related art. In order to solve the above-mentioned problem of the hollow-sealing type organic EL display device, the example discloses a technique in which an inorganic passivation film, an organic planarizing film and another inorganic passivation film are formed on an organic EL display panel where the organic EL layer and the upper electrode are provided without using a sealing substrate. Such sealing structure is hereinafter referred as to solid sealing. Here, a SiN film, a SiO₂ film or the like is used for the organic passivation film.

JP-A-2003-308964 discloses a structure in which the inner side of the sealing substrate is coated with a rubber material in order to enhance an impact resistance and a flexural strength of the organic EL device. However, a typical rubber material is not transparent so that it cannot be used for the top-emission type organic EL display device.

JP-A-2003-308964 also discloses a structure in which a rubber member is formed on the inner side of the sealing member in order to improve a protection property of the organic EL layer against moisture and gas. In order to dispose such rubber member, however, a frame area or a width of the peripheral area of the display region has to be made large in the organic EL display device. One problem in a small-sized organic El display device is a request for a large frame part since there is a strong demand for a larger display region while maintaining a prescribed outer shape and size of the device.

JP-A-2007-156058 discloses the sold-sealing type organic EL display device that can solve a problem of the hollow-sealing. The sold-sealing type organic EL display device is relatively robust and capable of making the device thinner. However, a multilayered structure in which the organic film and the inorganic film are layered is prone to have a pinhole in the organic film. Particularly, a film where the organic EL element is formed has an uneven surface due to existence of a bank and the like therefore the inorganic film that is disposed under the film is susceptible to pinholes. When the pinhole is generated in the inorganic film, water enters inside through the pinhole and eventually reaches the organic EL layer after a long period time, deteriorating luminescence characteristics of the organic EL layer. Moreover, the inorganic film and the organic film are generally fabricated by photolithography therefore the fabrication of the films is expensive.

Another problem of the organic EL display device resides in a sealing part that uses an organic material. The organic EL layer provided in a display region can be deteriorated by moisture so that it is sealed with a sealing part. However when the sealing part is made of an organic resin, a small amount of moisture can penetrate the organic resin and the moisture enters inside the organic EL display device after a long time operation, deteriorating the organic EL layer. In order to reduce the penetration of the water through the sealing part made of an organic material, it is necessary to make a width of the sealing member large. When the width of the sealing member is made large, a width of the frame area becomes large, which contradicts the request for the larger display region while maintaining the prescribed profile.

Particularly in the solid sealing type, an organic material is used to form a planarizing film and the like which is disposed under or over the organic EL layer, and it is conventionally difficult to provide only the sealing part which is made of an inorganic material alone without using an organic material.

### SUMMARY OF THE INVENTION

The present invention has an object to realize an organic EL display device with a fine product-life property and in which moisture intrusion into the organic EL display device is minimized by sealing an organic EL layer only with an inorganic material. It is also an object of the invention to realize a feature in which a width of a frame area is made small and a display region is made large with respect to a prescribed external form of the device by providing a sealing part which is made of an inorganic material.

In view of the above problems in the conventional art, the invention has the following features to solve the problems.

In a first aspect of the invention, an organic electro-luminescence (EL) display device includes an element substrate having a display region in which a pixel is arranged in matrix, the pixel having an organic EL layer that is disposed between a lower electrode and an upper electrode, and a thin film transistor (TFT), a sealing part surrounding the display region; and a laminate film disposed over the display region and having a thermoplastic adhesive member on one side and a barrier layer against moisture on another side. The thermoplastic adhesive member of the laminate film is bonded to the upper electrode in the display region, and the display region is sealed at an edge of the laminate film with a metal oxide that is formed by solidifying a paste including metal oxide particles, nonaqueous solvent and metal alkoxide as binder.

In this case, an organic film may not exist between the element substrate and the metal oxide in the sealing part, the metal oxide being formed by solidifying the metal-alkoxide-contained paste.

It is preferable that a metal in the metal alkoxide be Al.

It is also preferable that the barrier layer of the laminate film be a deposited film of alumina or silica, or a co-deposited film of alumina and silica.

In a second aspect of the invention, An organic electro-luminescence (EL) display device includes an element substrate having a display region in which a pixel is arranged in matrix, the pixel having an organic EL layer that is disposed between a lower electrode and an upper electrode, and a thin film transistor (TFT), a sealing part surrounding the display region and a sealing substrate disposed over the display region with an adhesive member interposed therebetween. The display region is sealed at an edge of the sealing substrate with a metal oxide that is formed by solidifying a paste including metal oxide particles, nonaqueous solvent and metal alkoxide as binder.

In this case, an organic film may not exist between the element substrate and the metal oxide in the sealing part, the metal oxide being formed by solidifying the metal-alkoxide-contained paste.

It is preferable that a metal in the metal alkoxide be Al.

It is also preferable that the adhesive member be a thermosetting adhesive.

It is also preferable that the adhesive member be a thermoplastic adhesive.

According to the first aspect of the invention, the organic EL element provided on the element substrate is protected by the laminate film that includes the barrier layer against water, and the metal oxide fabricated from the metal alkoxide seals between the periphery of the laminate film and the element substrate. Therefore the organic EL element is equipped with a high protection property against moisture and it is possible to realize an organic EL display device with a long product life.

According to the second aspect of the invention, the glass sealing substrate is bonded as a barrier against moisture over the organic EL element, and the metal oxide which is formed from the metal alkoxide seals between the periphery of the sealing substrate and the element substrate. Therefore the organic EL element is equipped with a high protection property against moisture and it is possible to realize an organic EL display device with a long product life.

According to the aspects of the invention, the sealing part is formed only from an inorganic film so that the width of the frame area is made small and the size of the display can be made large. Moreover, it is possible to realize a low-cost and highly-reliable solid sealing structure.

### BRIEF DESCRIPTION OF THE DRAWINGS

FIG. 1 is a sectional view of an organic EL display device according to a first embodiment of the invention;

FIG. 2 is a perspective view of an organic EL display panel according to the first embodiment;

FIG. 3 shows a chemical formula showing a reaction of metal alkoxide in the atmosphere;

FIG. 4 is a schematic sectional view of the organic EL display device according to the first embodiment;

FIG. 5 is a sectional view of an organic EL display device according to a second embodiment of the invention; and

FIG. 6 is a perspective view of the organic EL display panel according to the second embodiment.

### DESCRIPTION OF EXEMPLARY EMBODIMENTS

Embodiments of the invention will be now described.

### First Embodiment

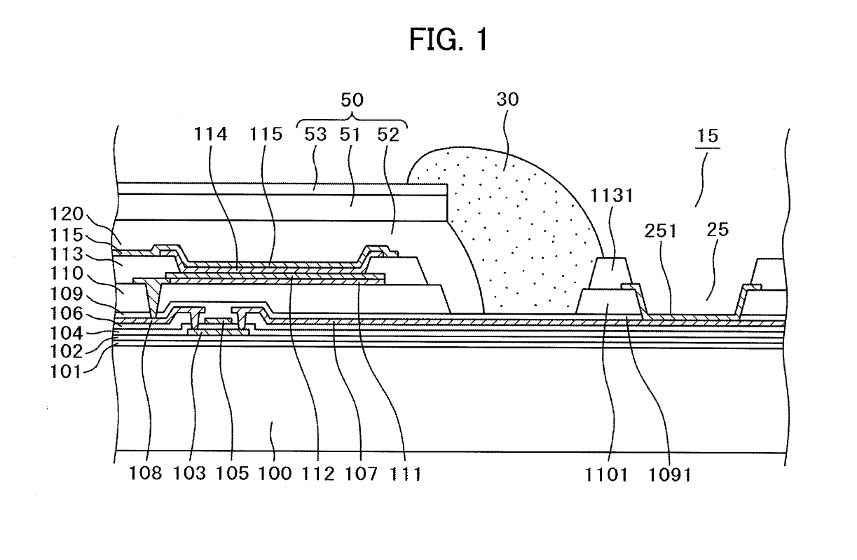

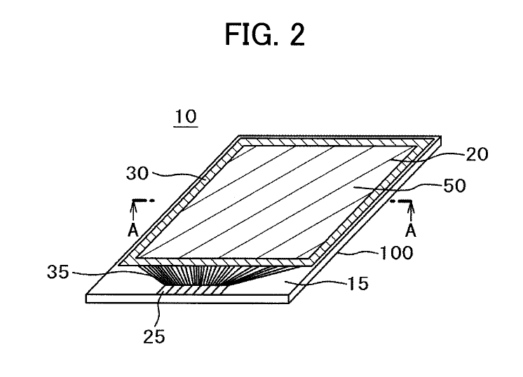

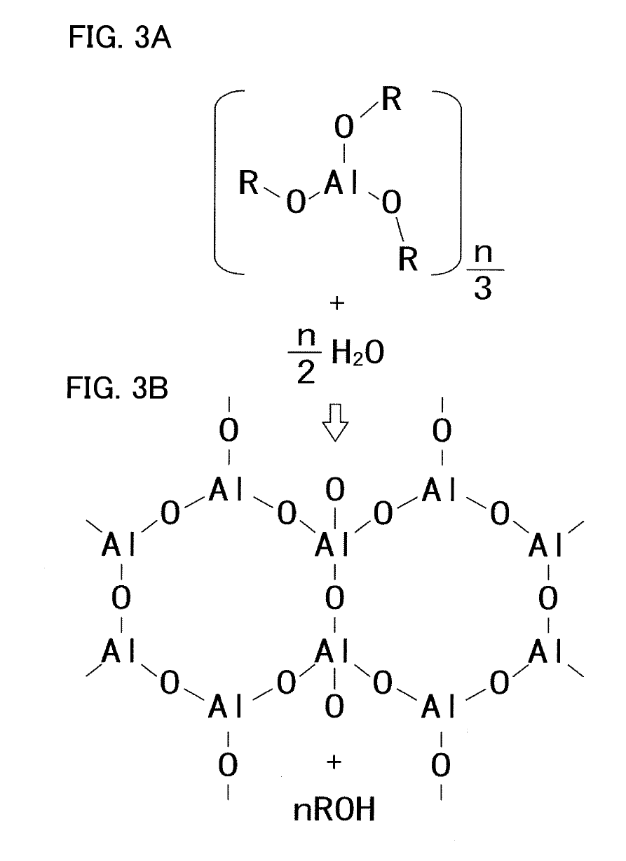

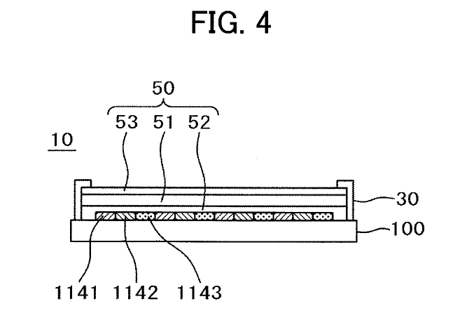

FIG. 1 is a sectional view of an organic EL display device according to the invention, FIG. 2 is a perspective view of an organic EL display device to which the invention is applied, FIG. 3 is a chemical formula showing a reaction of metal alkoxide that is used as a sealing material, and FIG. 4 is a schematic sectional view of the organic EL display device in a shorter side direction in FIG. 2.

Referring to FIG. 2, a display region 20 and a terminal region 15 are formed on an element substrate 100 which is made of glass. The display region 20 is covered with a laminate film 50 in which a deposited film of silica (SiO₂) or alumina (Al₂O₃) or a co-deposited film of them is provided on the surface as a barrier layer against moisture. A base member of the laminate film is made of for example polycarbonate, poly-ethylene terephthalate (PET) or the like. A periphery of the display region 20 is sealed with an inorganic sealing member 30 which is mainly made of alumina. In other words, a peripheral area of the laminate film 50 is sealed with the inorganic sealing member 30 since an organic film is water-permeable. The sealing member 30 is fabricated by using a metal alkoxide, which will be described later.

The terminal region 15 is formed outside the display region 20. An extraction line 35 of a scan line, an image signal line, a power line and the like is extended to the terminal region 15 and then coupled to a terminal part 25 that is provided in the terminal region 15. A scan signal, an image signal, electric current and the like are supplied through the terminal part 25.

FIG. 1 is a sectional view of the device schematically showing a structure according to the invention. FIG. 1 illustrates a part of the display region 20, a sealing part and a cross-section of the terminal region 15. In the following description, the organic EL display device 10 is described as the top-emission type. However, the invention is not limited to this but can also be applied to the bottom-emission type organic EL display device.

Referring to FIG. 1, in the display region 20, a first base film 101 made of SiN is formed on the element substrate 100 which is made of glass, and a second base film 102 made of SiO₂ is provided on the first base film. The first base film 101 and the second base film 102 are provided in order to prevent properties of a semiconductor layer 103 from being deteriorated due to contamination of impurities that are separated from the glass substrate.

The semiconductor layer 103 is provided on the second base film 102. In this embodiment, the semiconductor layer 103 is formed of poly-Si and has a thickness of about 50 nm. To form the poly-Si semiconductor layer 103, an a-Si layer is firstly formed, the a-Si layer is then annealed by using an excimer laser and the like in order to transform the layer into a poly-Si layer.

A gate electrode 105 is provided on the semiconductor layer 103. The gate electrode 105 is formed in the same layer as that of a gate wiring line. In the semiconductor layer 103, a channel part, a source region and a drain region are provided. The source region and the drain region are formed by adding impurities into the semiconductor layer 103 through ion implantation which utilizes the gate electrode 105 as a mask.

An interlayer insulation film 106 is formed of SiN or the like so as to over the gate electrode 105. A source wiring line 108 and a drain wiring line 107 are formed on the interlayer insulation film 106. In this embodiment, the drain wiring line 107 also serves as an image signal line. Since electric current which is used to make an organic EL layer 114 produce luminescence runs through the source wiring line 108 and the drain wiring line 107, these wiring lines are made of Al which is a low-resistance metal and have a relatively large thickness of about 700 nm. Under the Al wiring line, a barrier metal which is made of a high-melting-point metal such as Mo and Ti is provided to prevent semiconductors and the like from being contaminated by Al. Over the Al wiring line, a cap metal which is made of a high-melting-point metal such as Mo and Ti is provided to prevent hillock of Al.

The source wiring line 108 and the drain wiring line 107 are coupled with the source region and the drain region of the semiconductor layer 103 respectively via through-holes which are formed in a gate insulation film 104 and the interlayer insulation film 106. The drain wiring line 107 passes the peripheral sealing region 30 and extends to the terminal part 25. The source wiring line 108 is coupled to a lower electrode 112 of the organic EL layer 114.

An inorganic passivation film 109 is formed of SiN or the like so as to cover the source wiring line 108 and the drain wiring line 107. A main role of the inorganic passivation film 109 is to protect the TFT from outside impurities. An organic passivation film 110 is formed on the inorganic passivation film 109. A role of the organic passivation film is to protect the TFT and to planarize the surface. With the film, the organic EL layer 114 can be formed on a flat surface and it is possible to prevent the organic EL layer 114 from breaking off.

A reflective film 111 made of a high-reflectivity metal such as Al and Ag is provided on the organic passivation film 110. In this embodiment, the organic EL display device 10 is the top-emission type so that light emitted from the organic EL layer 114 is reflected toward the upper side in FIG. 1 by the reflective film 111 with which a light use efficiency is enhanced.

On the reflective film 111, the lower electrode 112 which is made of a transparent conductive film, indium tin oxide (ITO), and serves as an anode for the organic EL layer 114 is deposited. The ITO that serves as the lower electrode 112 is coupled to the source wiring line 108 through a through-hole which is formed in the inorganic passivation film 109 and the organic passivation film 110.

On the lower electrode 112, the organic EL layer 114 is formed. The organic EL layer 114 generally includes more than one layer. For example, naming from the anode side, the EL layer includes a hole injection layer having a thickness of 50 nm, a hole transport layer having a thickness of 50 nm, an emissive layer having a thickness of 20 nm, an electron transport layer having a thickness of 20 nm, an electron injection layer having a thickness of 1 nm and the like. Each layer is very thin and even the thickness of all the above-mentioned five layers is only amounted to about 140 nm.

A bank 113 that defines each pixel and is made of an acrylic resin is formed on the lower electrode 112 and the organic passivation film 110. As described above, each layer included in the organic EL layer 114 is very thin so that the layer can be broken off at portions having bump or difference in level. The bank 113 has a role to prevent such breakage particularly at end portions of the organic EL layer 114.

An upper electrode 115 which is made of a transparent conductive film, indium zinc oxide (InZnO), and serves as a cathode is provided on the organic EL layer 114. Both the InZnO and ITO are transparent conductive films but the InZnO has a lower resistance before annealing is conducted. Annealing cannot be performed after the organic EL layer 114 is deposited since the organic EL layer 114 is weak against heat, therefore the InZnO is used for the cathode.

Through the above-described steps, the element substrate 100 side of the typical organic EL display device 10 is completed. Luminescence characteristics of the organic EL element are deteriorated by water, and therefore sealing to block moisture in the atmosphere is required. According to the invention, the display region 20 where the organic EL element is formed is sealed by covering the region with the laminate film 50.

The laminate film 50 includes a base member which is a transparent resin film such as an acrylic film and a polycarbonate film, and a barrier layer 53 on its surface. The barrier layer 53 is a deposited film of alumina, silica or the like or a co-deposited film on the surface. The alumina film, the silica film and the co-deposited film thereof are inorganic films and they are water impermeable. In order to ensure the effect of the barrier layer 53, the barrier layer 53 is made thick for example in several micrometers (μm) thick.

The barrier layer 53 does not let moisture penetrate. However, the barrier layer 53 can be partially broken when the laminate film base member 51 that is made of resin is mechanically stretched, and moisture can enter through the broken part of the barrier layer. Therefore the laminate film base member 51 has to be mechanically strong so that a film thickness is set to about 50 μm.

Under the laminate film 50, a thermoplastic adhesive member 52 is coated. A polypropylene-series resin is used for the thermoplastic adhesive. The thermoplastic adhesive is applied 10 to 20 μm thick onto the laminate film base member 51. This laminate film 50 is laminated in the display region 20 where the organic EL element is disposed by a commonly-used laminating machine. At this point, the thermoplastic adhesive member 52 is softened by heat, the softened thermoplastic adhesive member 52 spreads outside from the periphery of the laminated film 50 and covers side faces of the organic EL element.

In the structure described above with reference to FIG. 1, a front face of the organic EL element is protected by the laminate film 50 that has the barrier layer 53, thereby moisture does not penetrate the front face. However, the barrier layer 53 is not provided on the side face of the organic EL element and the side faces are only covered with the thermoplastic adhesive member 52. Moisture seeps over a long time from here and the organic EL elements that are situated close to the periphery of the display region 20 are deteriorated.

According to the invention, the periphery of the display region 20, in other words, the periphery of the laminate film 50 is sealed with the inorganic sealing member 30 as illustrated by FIG. 1, thereby the moisture penetration from the side faces is prevented. Referring to FIG. 1, the inorganic sealing member 30 covers an edge of the barrier layer 53 of the laminate film 50, covers the side faces of the laminate film base member 51 and the thermoplastic adhesive member 52, and covers a part of the inorganic passivation film 109 that is situated in the sealing part.

Referring to FIG. 1, the drain wiring line 107 that is coupled with the terminal passes under the inorganic sealing member 30. The first base film 101, the second base film 102, the gate insulation film 104 and the interlayer insulation film 106 are provided under the drain wiring line 107. The inorganic passivation film 109 is situated over the drain wiring line 107. In other words, the sealing part is formed of only inorganic material.

As described above, the inorganic sealing member 30 is formed directly on the inorganic passivation film and an organic film does not exist in the sealing part. Moisture permeates organic films albeit only slightly. If the sealing part is formed from an organic film alone and tries to reduce the water permeation, a width of the organic film has to be made large, resulting in a large frame area that is disposed around the display region 20. According to the embodiment, the sealing part is made of only the inorganic material that is water-impermeable thereby it is possible to make the width of the frame area small.

If the sealing member is formed of an organic material, it is necessary to set the width of the sealing member to 1.2 mm or larger in order to reduce the moisture penetration. However, when the sealing member is made of an inorganic material, it is possible to set the width of the sealing member to 0.1 mm or smaller. Consequently it is possible to realize a small width of the frame area.

A fabrication method for the inorganic sealing member 30 according to the invention will be now described. The periphery of the display region 20 is sealed with a nonaqueous inorganic adhesive including metal alkoxide as binder, alumina as filler and alcohol as solvent. The metal alkoxide, which is the binder, solates and is then solidified while it absorbs water and releases alcohol so that water is not released when it becomes solidified. Therefore properties of the organic EL element are not adversely affected.

FIG. 3 illustrates the above-described change from the inorganic adhesive to the inorganic sealing member 30. FIG. 3A is a chemical formula showing existence of the metal alkoxide and water. Referring to FIG. 3, “R” denotes an alkyl group and the metal here is Al. “H₂O” in FIG. 3A is moisture in the atmosphere. In the state shown in FIG. 3A, the metal alkoxide is in a paste form and it can be applied onto the periphery of the laminate film 50 by dispenser.

When the applied metal alkoxide is left at room temperature, the metal alkoxide reacts with moisture in the atmosphere, alcohol is released, and the metal alkoxide turns to alumina as a result of the reaction. FIG. 3B illustrates this reaction. In FIG. 3B, “R” is an alkyl group and “ROH” is an alcohol. Referring to FIG. 3B, the metal alkoxide does not release moisture but solates while it absorbs moisture so that the organic EL element is not adversely affected. Moreover, after the solation, the inorganic member 30 turns into alumina alone which is an inorganic substance and its barrier property against moisture is very strong. Therefore the inorganic sealing member 30 according to the invention is highly appropriate for sealing the organic EL display device 10.

Though the metal in the metal alkoxide is Al in the above-described embodiment, the metal is not limited to this but can be Si, Ti, Sn or the like.

Referring to FIG. 1, the drain wiring line 107 that extends to the terminal region 15 is covered with a protection film 1091 that is made of the same layer as the first inorganic passivation 109, a protection film 1101 that is made of the same layer as the organic passivation film 110 and a protection film 1131 that is made of the same layer as the bank 113 thereby the wiring line is protected from the outside air. The drain wiring line that is extended and situated in the terminal part 25 is covered with a transparent conductive film 251 that is made of the same layer as the lower electrode thereby the wiring line is protected.

FIG. 4 is a schematic sectional view of the organic EL display device 10 that is fabricated through the above described steps. FIG. 4 corresponds to a sectional view along the line A-A in FIG. 2. Referring to FIG. 4, an organic EL element is provided on the element substrate 100. The organic El element encompasses light-emitting pixels that include a red emissive layer 1141, a green emissive layer 1142, and a blue emissive layer 1143. The laminate film 50 covers the organic EL element. The laminate film 50 is adhesively bonded to the organic EL element with the thermoplastic adhesive member 52 that is coated on the laminate film base member 51. The barrier layer 53 that is made of a deposited film of alumina or silica and prevents moisture is provided on the laminate film base member 51.

The periphery of the laminate film 50 is covered with the inorganic sealing member 30. As described above, the inorganic sealing member 30 is formed of the metal alkoxide, the metal here is aluminum (Al). FIG. 4 illustrates the state in which the metal alkoxide reacts with oxygen in the atmosphere and the inorganic sealing member 30 becomes alumina.

Referring to FIG. 4, the periphery of the organic EL element is completely covered with the inorganic sealing member 30 so that moisture cannot seep into the organic EL element side from the periphery. Moreover, the surface of the organic EL element is covered with the laminate film 50 and the surface of the laminate film 50 is coated with the barrier layer 53 that is made of the inorganic film which blocks water. The EL element is completely surrounded by the inorganic film according to the embodiment therefore the device has an excellent barrier property against moisture.

### Second Embodiment

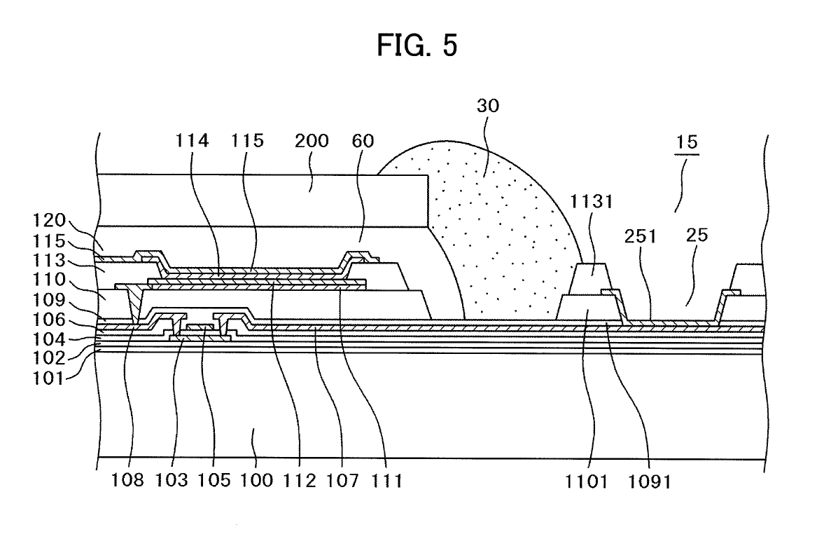

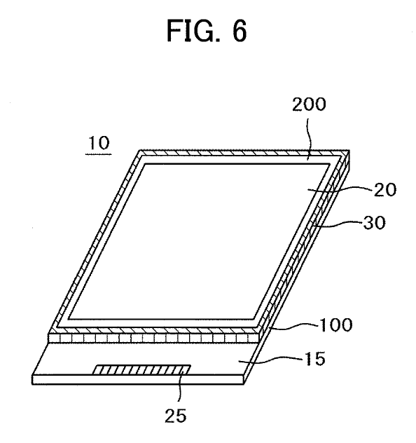

FIG. 5 is a sectional view showing a second embodiment of the invention, and FIG. 6 is a perspective view of the organic EL display device 10 according to the second embodiment. The organic EL element and a structure of the terminal region 15 illustrated in FIG. 5 are the same as those illustrated in FIG. 1 so that their descriptions will be omitted. Referring to FIG. 5, different features from the first embodiment shown in FIG. 1 are that the surface of the organic EL element is protected from moisture by a sealing substrate 200 which is made of glass instead of the laminate film 50.

Referring to FIG. 5, the sealing substrate 200 is adhesively bonded to the upper electrode with an adhesive layer 60 interposed therebetween. For example, an epoxy resin which is a thermosetting resin is used for the adhesive. When the element substrate 100 and the sealing substrate 200 are heated after the element substrate 100 and the sealing substrate 200 are bonded, the epoxy resin turns into fluid and the resin is completely adhered onto the upper electrode of the organic EL element because the epoxy resin is the thermosetting resin. Moreover, the epoxy resin becomes fluid when it is heated so that the resin flows out of the edge and this resin protects the side part of the display region 20. The epoxy resin is solidified when the temperature rises further and the organic EL display device 10 is sealed.

The organic EL display device 10 that is fabricated in the above-described way is protected by the sealing substrate 200 and the epoxy resin. In this structure, however, the side part of the organic EL element is protected only by the epoxy resin. The epoxy resin permeates moisture albeit only slightly and moisture can reach the organic EL element over a long time. Consequently the luminescence property of the organic EL element is deteriorated.

In order to prevent the deterioration, in the same manner as the first embodiment, the inorganic sealing member 30 is provided on the edge of the sealing substrate 200 and the side part of the epoxy resin that protrudes out from the substrate in a lateral direction in the second embodiment. A method for fabricating the inorganic sealing member 30 is the same as that of the first embodiment. More specifically, the metal alkoxide in a paste form is applied to the periphery of the sealing substrate 200 and the periphery of the display region 20 by a dispenser or the like. The metal alkoxide reacts with moisture in the atmosphere as illustrated in FIG. 3, and the part where the metal alkoxide exits turns into the inorganic sealing member 30 that is composed of alumina.

In the area where the inorganic sealing member 30 is provided over the element substrate 100, only the inorganic films such as the inorganic passivation film, the interlayer insulation film, the gate insulation film and the like exist but an organic film does not exist. Therefore the barrier property against moisture is excellent. Consequently it is possible to make the width of the sealing part smaller and the frame area of the organic EL display device 10 can be made small.

A method for fabricating the epoxy resin will be now described. A precisely controlled amount of the epoxy resin is discharged onto the element substrate 100 or the sealing substrate 200, the discharged epoxy resin is sandwiched between the element substrate 100 and the sealing substrate 200, and the epoxy resin is then spread evenly. In this way the sealing can be performed.

The epoxy resin described above is a thermosetting resin that becomes fluid when heated and then is solidified when it is further heated. In this case, the sealing substrate 200 is firstly aligned and placed on the element substrate 100, the epoxy resin is heated so that it becomes fluid, the resin is made fit with the organic EL element that is provided on the element substrate 100, a temperature of the epoxy resin is then risen so as to solidify the resin temporally, and the temperature is further risen so as to solidify it to a full scale. In this case, the temporary solidification of the resin can be performed on a jointing apparatus where the element substrate 100 and the sealing substrate 200 are jointed, and the full-fledged solidification of the resin can be conducted in a furnace. In this way it is possible to secure a practical takt time without providing many jointing apparatuses where the element substrate 100 and the sealing substrate 200 are jointed.

FIG. 6 is a perspective view of the organic EL display device 10 according to the second embodiment. Referring to FIG. 6, the sealing substrate 200 is disposed over the element substrate 100. Since both the element substrate 100 and the sealing substrate 200 are made of glass, there is no water permeation from the surfaces. Substrate thicknesses of the element substrate 100 and the sealing substrate 200 can be made the same or different. The element substrate 100 and the sealing substrate 200 are bonded with an unshown epoxy-resin-series adhesive. Referring to FIG. 6, the terminal part 25 is formed in the terminal region 15 of the element substrate 100. The extraction lines of the image signal line and the scan line that are provided in the terminal region 15 are not shown in FIG. 6.

In this embodiment, the sealing substrate 200 made of glass is adopted, which is the same as the case of the hollow-sealing. However, the epoxy resin is filled between the element substrate 100 and the sealing substrate 200 in this embodiment so that a mechanical strength is improved. Moreover, the embodiment does not have a problem of the hollow-sealing that the organic EL layer can come off from the element substrate 100 and the EL layer can stick to the sealing substrate 200 side when the element substrate 100 and the sealing substrate 200 contact and separate each other.

Referring to FIG. 6, the inorganic sealing member 30 that is formed of the metal alkoxide covers the edge and the side part of the sealing substrate 200 and the outside periphery of the unshown adhesive layer 60 that is made of the metal alkoxide and bonds the element substrate 100 and the sealing substrate 200. Thereby the organic EL element provided on the element substrate 100 is completely surrounded by the glass sealing substrate 200 and the inorganic sealing member 30 and the organic EL element is completely protected from moisture.

The adhesive layer 60 provided on the sealing substrate 200 is not necessarily made of epoxy resin but can also be made of a thermoplastic polypropylene-series resin like the one used in the first embodiment. The adhesive can also be made of acryl, silicon or the like.

In the case of a thermoplastic adhesive, a thermoplastic adhesive film is transferred onto the sealing glass substrate, the sealing substrate 200 on which the thermoplastic adhesive film is transferred is jointed with the element substrate 100 on which the upper electrode is formed by using a vacuum laminating method.

According to the embodiment described above, the organic EL element is surrounded by the inorganic material in order to protect the element from the moisture outside. Therefore it is possible to prevent the luminescence property of the organic EL element from being deteriorated, and the organic EL display device 10 with a fine product-life property can be obtained. In addition, it is possible to realize a small width of the frame area around the display region.

What is claimed is:

1. An organic electro-luminescence (EL) display device, comprising:
an element substrate having a display region in which a pixel is arranged in matrix, the pixel having an organic EL layer that is disposed between a lower electrode and an upper electrode, and a thin film transistor (TFT);
a sealing part surrounding the display region; and
a laminate film disposed over the display region and having a thermoplastic adhesive member on one side and a barrier layer against moisture on another side,
wherein the thermoplastic adhesive member of the laminate film is bonded to the upper electrode in the display region, and
the display region is sealed at an edge of the laminate film with a metal oxide that is formed by solidifying a paste including metal oxide particles, nonaqueous solvent and metal alkoxide as binder.

2. The organic EL display device according to claim 1, wherein an organic film does not exist between the element substrate and the metal oxide in the sealing part, the metal oxide being formed by solidifying the metal-alkoxide-contained paste.

3. The organic EL display device according to claim 1, wherein a metal in the metal alkoxide is Al.

4. The organic EL display device according to claim 1, wherein the barrier layer of the laminate film is a deposited film of alumina or silica, or a co-deposited film of alumina and silica.

5. An organic electro-luminescence (EL) display device, comprising:
an element substrate having a display region in which a pixel is arranged in matrix, the pixel having an organic EL layer that is disposed between a lower electrode and an upper electrode, and a thin film transistor (TFT);
a sealing part surrounding the display region; and
a sealing substrate disposed over the display region with an adhesive member interposed therebetween,
wherein the display region is sealed at an edge of the sealing substrate with a metal oxide that is formed by solidifying a paste including metal oxide particles, nonaqueous solvent and metal alkoxide as binder.

6. The organic EL display device according to claim 5, wherein an organic film does not exist between the element substrate and the metal oxide in the sealing part, the metal oxide being formed by solidifying the metal-alkoxide-contained paste.

7. The organic EL display device according to claim 5, wherein a metal in the metal alkoxide is Al.

8. The organic EL display device according to claim 5, wherein the adhesive member is a thermosetting adhesive.

9. The organic EL display device according to claim 5, wherein the adhesive member is a thermoplastic adhesive.
